(19) United States
(12) Patent Application Publication
(10) Pub. No.: US 2017/0374019 A1
(43) Pub. Date: Dec. 28, 2017

(54) QUERYING DOMAIN NAME INFORMATION

(71) Applicant: Alibaba Group Holding Limited, Grand Cayman (KY)

(72) Inventor: Cong Wei, Hangzhou (CN)

(73) Assignee: Alibaba Group Holding Limited

(21) Appl. No.: 15/635,009

(22) Filed: Jun. 27, 2017

(30) Foreign Application Priority Data
Jun. 28, 2016 (CN) 201610493481.3

(51) Int. Cl. H04L 29/12; H04L 12/911

(52) U.S. Cl. CPC H04L 61/1511; H04L 47/82; H04L 61/2007

(57) ABSTRACT

A method including receiving to-be-queried domain names; obtaining a query capacity of a preset query group; allocating the domain names to a matching query group according to the query capacity; and querying domain name information of the domain names through a query interface of the matching query group. In one aspect, by flexible domain name allocation, query resources are fully utilized, and the quantity of concurrent domain name queries is increased, thereby improving query efficiency and reducing a query time. In another aspect, queries are performed by using a particular query interface, and settings of the query interface are maintained, thereby avoiding that settings of the query interface need to be switched due to queries for different types of domain names, and improving query efficiency and reducing a query time.

### CROSS REFERENCE TO RELATED PATENT APPLICATIONS

This application claims priority to Chinese Patent Application No. 201610493481.3, filed on Jun. 28, 2016, entitled “METHOD AND APPARATUS FOR QUERYING DOMAIN NAME INFORMATION,” which is hereby incorporated by reference in its entirety.

### TECHNICAL FIELD

The present disclosure relates to the technical field of computer processing and, in particular, to a method and an apparatus for querying domain name information.

### BACKGROUND

Internet web sites are generally constructed in the form of servers. To locate these servers, Internet Protocol (IP) addresses are generally allocated.

However, there is an extremely large quantity of websites on the Internet, and the quantity is still growing continuously; therefore, when a user accesses servers of websites, it is basically impossible for the user to remember the IP address of every website.

To facilitate memorizing, a Domain Name System (DNS) was created in the Internet. Domain names that are easier to remember are proposed in the DNS, and an input domain name is converted into an IP address of a server, thereby accessing a website of the server.

For example, when a user enters a domain name: sipo.gov.cn in a browser, the DNS converts sipo.gov.cn into a corresponding IP address: 202.96.46.43.

In cases such as domain name registration and domain name trading, a user generally performs a Whois query on batches of domain names on a query website, that is, querying whether the domain names have been registered, detailed information of a registered domain name, and the like.

Currently, for the Whois query for batches of domain names, the query website generally provides a fixed number of universal query interfaces, and the query is performed by means of polling.

As the query interfaces are fixed, different types of domain names are usually queried by using a same query interface, and settings of the query interface need to be switched, thereby resulting in low efficiency.

In addition, block waiting is unavoidable in the polling method, and thus, a waiting time of a Whois query for batches of domain names is relatively long. For example, a Whois query for more than 20 domain names usually results in a wait time of more than 3 minutes; even worse, a timeout often occurs for the query, and sometimes, invalid queries account for 30% of returned results.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of the foregoing problem, example embodiments of the present disclosure are proposed to provide a method for querying domain name information and a corresponding apparatus for querying domain name information, which overcome the foregoing problem or at least partially solve the foregoing problem.

According to an aspect, an example embodiment of the present disclosure provides a method for querying domain name information, including:

receiving domain names;

obtaining a query capacity of a preset query group;

allocating one or more domain names of the domain names to a matching query group according to the query capacity; and

querying domain name information of the one or more domain names through a query interface of the matching query group.

the obtaining the query capacity of the preset query group includes:

identifying a query interface of the preset query group;

searching for a concurrent query quantity of the query interface; and

calculating a sum of the concurrent query quantities to obtain the query capacity.

For example, the obtaining the query capacity of the preset query group includes:

identifying a query interface of the preset query group;

searching for a concurrent query quantity of the query interface; and

calculating a sum of the concurrent query quantities to obtain the query capacity.

For example, wherein the allocating the one or more domain names of the domain names to the matching query group according to the query capacity includes:

identifying a specified-level domain name in the domain names;

searching for a matching query group of the specified-level domain name, a query interface of the query group being used for querying domain name information of the one or more domain names to which the specified-level domain name belongs; and

allocating the one or more domain names to the query group according to the query capacity of the query group.

For example, the specified-level domain name includes one or more of the following types:

a top-level domain;

a second-level domain; and

a third-level domain.

For example, the querying the domain name information of the one or more domain names through the query interface of the matching query group includes:

determining a concurrent query quantity of the query interface in the matching query group;

allocating the one or more domain names in the matching query group to the query interface until the concurrent query quantity is reached; and

querying domain name information of the one or more domain names through the query interface.

For example, the method further includes:

counting a remaining quantity of remaining domain names that match the query group and are not allocated to the query group; and

calling a query interface for the query group according to the remaining quantity.

For example, the calling the query interface for the query group according to the remaining quantity includes occupying one or more new query interfaces according to the remaining quantity.

The remaining quantity is proportional to a quantity of the one or more new query interfaces.

For example, the calling the query interface for the query group according to the remaining quantity includes releasing a query interface in an idle state when the remaining quantity is zero.

For example, the method further includes:

sorting the domain name information according to a sequence of the domain names.

For example, the method further includes:

outputting the domain name information for display.

According to another aspect, an example embodiment of the present disclosure further provides an apparatus for querying domain name information, including:

a to-be-queried domain name receiving component configured to receive domain names;

a query capacity obtaining component configured to obtain a query capacity of a preset query group;

a domain name allocation component configured to allocate one or more domain names of the domain names to a matching query group according to the query capacity; and

a domain name information query component configured to query domain name information of the one or more domain names through a query interface of the matching query group.

For example, the query capacity obtaining component includes:

a query interface identification sub-component configured to identify a query interface of the preset query group;

a concurrent query quantity searching sub-component configured to search for a concurrent query quantity of the query interface; and

a summation sub-component configured to calculate the sum of the concurrent query quantities to obtain the query capacity.

For example, the domain name allocation component includes:

a level domain name identification sub-component configured to identify a specified-level domain name in the domain names;

a query group searching sub-component configured to search for a matching query group of the specified-level domain name, a query interface of the query group being used for querying domain name information of the one or more domain names to which the specified-level domain name belongs; and

a query group allocation sub-component configured to allocate the domain names to the query group according to the query capacity of the query group,

wherein the specified-level domain name comprises one or more of the following types:

a top-level domain, a second-level domain, and a third-level domain.

For example, the domain name information query component includes:

a concurrent query quantity determination sub-component configured to determine a concurrent query quantity of the query interface in the matching query group;

an interface filling sub-component configured to allocate the one or more domain names in the matching query group to the query interface until the concurrent query quantity is reached; and

an interface query sub-component configured to query domain name information of the one or more domain names through the query interface.

For example, the apparatus further includes:

a remaining quantity counting component configured to count a remaining quantity of remaining domain names that match the query group and are not allocated to the query group; and

a query interface calling component configured to open a query interface for the query group according to the remaining quantity.

For example, the query interface calling component includes:

a query interface occupation sub-component configured to occupy occupying one or more new query interfaces according to the remaining quantity; or

a query interface releasing sub-component configured to release a query interface in an idle state when the remaining quantity is zero.

For example, the apparatus further includes:

a domain name information sorting component configured to sort the domain name information according to a sequence of the domain names.

For example, the apparatus further includes:

a domain name information output component configured to output the domain name information for display.

According to another aspect, an example embodiment of the present disclosure provides one or more memories stored thereon computer-readable instructions that, when executed by one or more processors, cause the one or more processors to perform acts comprising:

receiving domain names;

obtaining a query capacity of a preset query group;

allocating one or more domain names of the domain names to a matching query group according to the query capacity; and

querying domain name information of the one or more domain names through a query interface of the matching query group.

For example, the allocating the one or more domain names of the domain names to the matching query group according to the query capacity includes:

identifying a specified-level domain name in the domain names;

searching for a matching query group of the specified-level domain name, a query interface of the query group being used for querying domain name information of the one or more domain names to which the specified-level domain name belongs; and

allocating the one or more domain names to the query group according to the query capacity of the query group.

The other features in this example embodiment may be referenced to the method and apparatus embodiments of the present disclosure.

The example embodiments of the present disclosure include the following advantages:

The example embodiments of the present disclosure allocate to-be-queried domain names to a matching query group according to a query capacity of the query group, and perform queries by using a query interface in the query group. In one aspect, by flexible domain name allocation, query resources are fully utilized, and the quantity of concurrent domain name queries is improved, thereby improving query efficiency and reducing a query time. In another aspect, queries are performed by using a particular query interface, and settings of the query interface are maintained, thereby avoiding that settings of the query interface need to be switched due to queries for different types of domain names, which improves query efficiency and reducing a query time.

The example embodiments of the present disclosure dynamically occupy or release a query interface of a query group based on the quantity of remaining domain names, and fully utilize query resources by means of flexible query interface configuration; for domain names of different scales, an adapted query interface can be adjusted, thereby improving query efficiency and reducing a query time.

The example embodiments of the present disclosure, by querying domain names in a non-block query manner, reduce a query time and phenomena of timeout due to long-time waiting compared with block waiting.

### BRIEF DESCRIPTION OF THE DRAWINGS

In order to describe the technical solutions in the example embodiments of the present disclosure clearly, the accompanying drawings to be used in the description of the example embodiments are briefly introduced in the following. It is apparent that the accompanying drawings in the following description merely represent some of the example embodiments of the present disclosure, and those of ordinary skill in the art may also obtain other drawings according to the accompanying drawings.

FIG. 1 is a flowchart of an example method for querying domain name information according to an example embodiment of the present disclosure;

FIG. 2 is a diagram of an example of groups and query interfaces according to an example embodiment of the present disclosure;

FIG. 3 is a flowchart of an example method for querying domain name information according to another example embodiment of the present disclosure;

FIG. 4A and FIG. 4B are diagrams of examples of group queries of a domain name query system according to an example embodiment of the present disclosure;

FIG. 5 is a diagram of a display example of domain name information according to an example embodiment of the present disclosure;

FIG. 6 is a structural block diagram of an example apparatus for querying domain name information according to an example embodiment of the present disclosure; and

FIG. 7 is a structural block diagram of an example apparatus for querying domain name information according to another example embodiment of the present disclosure.

### DETAILED DESCRIPTION

To make the above objectives, features, and advantages of the present disclosure clearer and more comprehensible, the present disclosure is described in further detail below with reference to the accompanying drawings and example implementations.

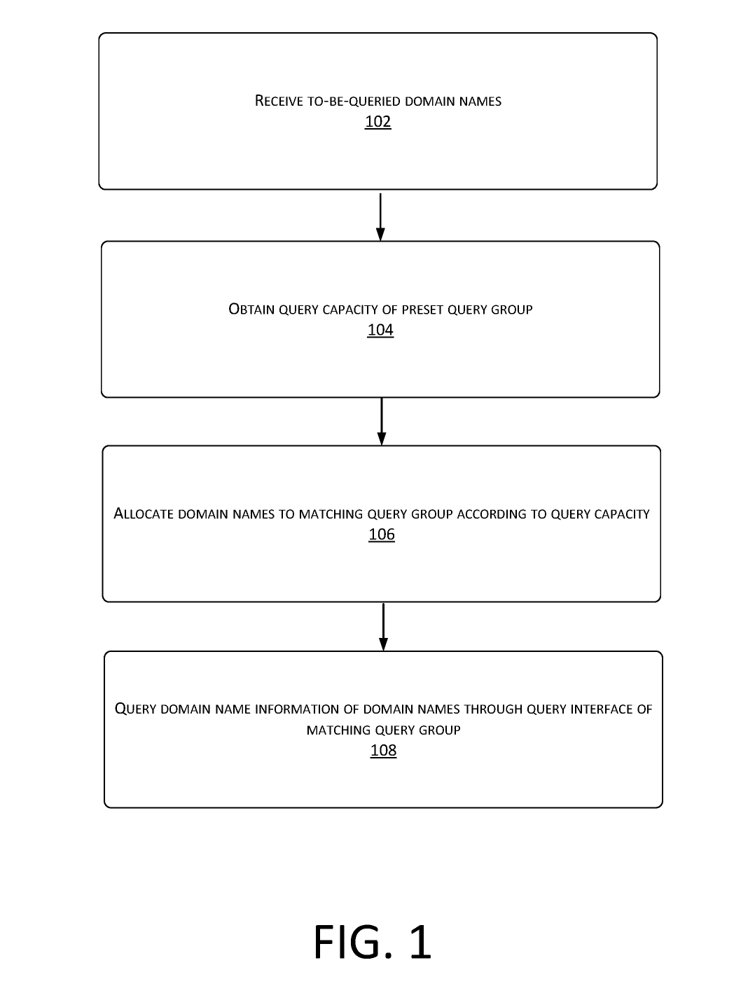

Referring to FIG. 1, a flowchart of steps of an example method for querying domain name information according to an example embodiment of the present disclosure is shown, which may specifically include the following steps:

Step 102: To-be-queried domain names are received.

In an example implementation, a user may send to-be-queried domain names, generally batches of domain names, to a server through a client terminal (such as a browser).

For example, the user may access a webpage of the server through the browser, and submit a document of a format such as TXT on the webpage. The document records domain names, and each domain name is distinguished with a line break.

An example of the document may be as follows:

sipo.gov.cn

www.sipo.com

sipo.fm

sipo.xin

For another example, the user may access a webpage of the server through the browser. An input field is provided on the webpage, and the user inputs domain names in the input field; each domain name is distinguished with a space.

It should be noted that to-be-queried domain names received by the server may be sent by the same user, or may be sent by different users, which is not limited in the example embodiment of the present disclosure.

Step 104: A query capacity of a preset query group is obtained.

In an example implementation, if the server receives to-be-queried domain names, according to the query capacity of each query group, suitable domain names are allocated to the query group.

In an example embodiment of the present disclosure, Step 104 may include the following sub-steps (not shown in FIG. 1):

A first sub-step of 104: A query interface of the preset query group is identified.

A second sub-step of 104: A concurrent query quantity of the query interface is searched for.

A third sub-step of 104: The sum of the concurrent query quantities is calculated to obtain the query capacity. In application of the example embodiment of the present disclosure, one or more query groups may be preset, and one or more query interfaces, that is, Application Programming Interfaces (APIs), are configured in each query group, for querying domain name information of domain names in the query group.

These query interfaces generally may be defined by using a key-value data storage interface.

Certainly, the query interfaces may also be defined in forms such as a server sequence, and arrays of other structures, which is not limited in the example embodiment of the present disclosure.

In an example implementation, the query interface may specify a concurrent query quantity, that is, a maximum quantity of domain names that are concurrently queried in one query operation.

For example, if the concurrent query quantity of a query interface is 5, it means that the query interface concurrently queries domain name information of 5 domain names at most in one query operation.

As one or more query interfaces may be configured in one query group, the sum of concurrent query quantities of all query interfaces is calculated to obtain the query capacity of the query group.

Step 106: The domain names are allocated to a matching query group according to the query capacity.

In the example embodiment of the present disclosure, the domain names may be allocated to a matching query group, until the quantity of domain names in the query group reaches an upper limit of the query capacity, or until all the domain names are allocated.

If the domain names allocated to the matching query group reach the upper limit of the query capacity, and there are remaining domain names that are not allocated, the allocation may be suspended to wait for the next query. In an example embodiment of the present disclosure, Step 106 may include the following sub-step (not shown in FIG. 1):

A first sub-step of 106: A specified-level domain name in the domain names is identified.

In an example implementation, domain names generally may be classified into multiple levels; the specified-level domain name is a domain name of a specified level, and may include one or more of the following types:

a top-level domain, a second-level domain, and a third-level domain.

Certainly, in addition to the top-level domain, second-level domain, and third-level domain, the specified-level domain name may further be a domain name of another level, which is not limited in the example embodiment of the present disclosure.

To help those skilled in the art better understand the example embodiment of the present disclosure, in this specification, the top-level domain is used as an example of the specified-level domain name for description.

A domain name includes two or more terms separated by a dot mark, and the rightmost term is referred to as a top-level domain, also known as a suffix.

In actual application, the top-level domain generally includes several classes as follows:

1. Country Code Top-Level Domains (nTLDs)

Currently, top-level domains are allocated to over 200 countries according to the ISO3166 country code. For example, the top-level domain of China is .cn, the top-level domain of Japan is .jp, the top-level domain of the US is .us, and so on.

2. Generic Top-Level Domains (gTLDs)

For example, .com that represents industrial and commercial enterprises, .net that represents network providers, .org that represents non-profit organizations, and so on.

3. New gTLD Overview

For example, .aero represents aeronautic organizations, .post represents postal organizations, and .museum represents museums, and so on.

A second sub-step of 106: A matching query group of the specified-level domain name is searched for.

A third sub-step of 106: The domain names are allocated to the query group according to the query capacity of the query group.

In the example embodiment of the present disclosure, a query interface of the query group is used for querying domain name information of the domain names to which the specified-level domain names belong.

Some query interfaces may be used for querying only one type of specified-level domain name, while some query interfaces may be used for querying two and more types of specified-level domain names; therefore, one query group may contain one type of specified-level domain name, or may contain two or more types of specified-level domain names.

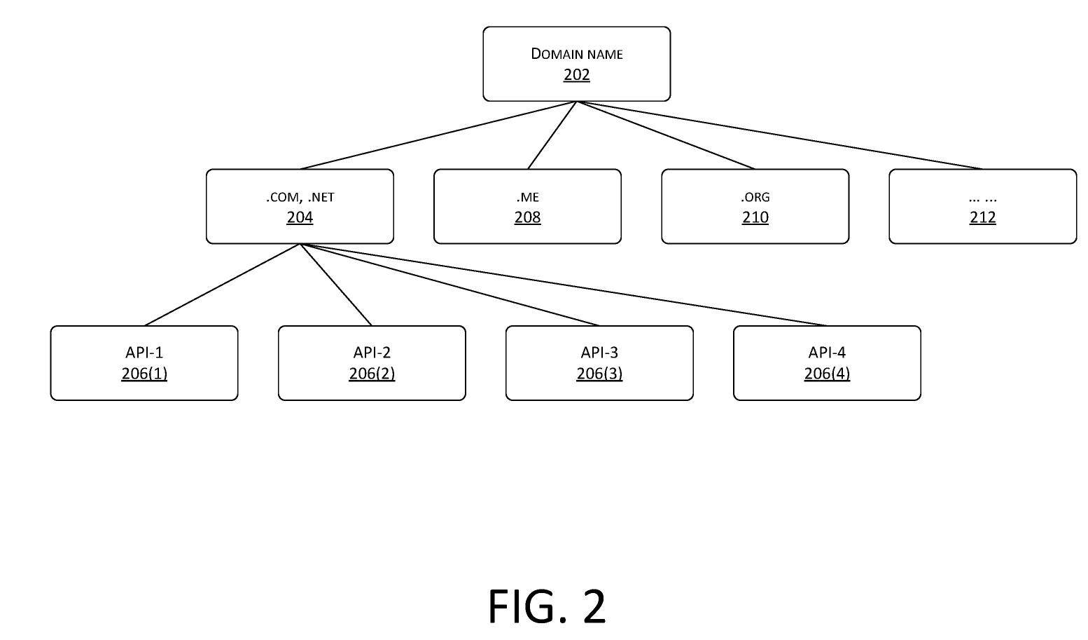

For example, as shown in FIG. 2, under a tree of domain name 202, assuming that the top-level domains .com and .net 204 may be queried by using the same one or more query interfaces, such as a query interface API-1 206(1), a query interface API-2 206(2), a query interface API-3 206(3), a query interface API-4 206(4), the same query group may be set to contain domain names to which the top-level domains .com and .net 204 belong; assuming that the top-level domains .me 208 and .org 210 are queried by using independent query interfaces, respective groups may be set to separately contain domain names to which the top-level domains .me and .org belong; and so on for other top-level domain name 212.

Because query interfaces of query groups provide different query capacities, in the example embodiment of the present disclosure, query groups may be dynamically classified according to the query capacities.

A fourth sub-step of 106: Domain names in the matching query group are allocated to the query interface until the concurrent query quantity is reached.

A fifth sub-step of 106: Domain name information of the allocated domain names are queried through the query interface

In the example embodiment of the present disclosure, domain names may be allocated to the query group, until the quantity of domain names in the query group reaches an upper limit of the total concurrent query quantity, or all domain names are allocated.

If the domain names allocated to the query group reach the upper limit of the concurrent query quantity, and there are remaining domain names that are not allocated, the allocation may be suspended to wait for the next query.

For example, a query group is allocated with 4 query interfaces for domain names with the top-level domain .com, and concurrent query quantities of the 4 query interfaces are 5, 5, 10, and 10 respectively.

When there are 10 domain names with the top-level domain .com, the concurrent query of the 10 domain names occupies a query interface of which the concurrent query quantity is 10, the other three query interfaces are in an idle state, and all the domain names are allocated to the query group.

When there are 100 domain names with the top-level domain .com, if all the query interfaces are used for the query at full load, making the total concurrent query quantity be 30, 30 domain names are allocated to the query group, and the remaining 70 domain names wait for the next query.

Step 108: Domain name information of the domain names is queried through a query interface of the matching query group.

In the example embodiment of the present disclosure, pre-processing may be performed on domain names in the query group to improve query efficiency of the domain names.

The pre-processing may include:

1. Validity Check

In this pre-processing, validity check may be performed on the domain names in the query group. When a domain name is determined to be invalid, the domain name is deleted. When the domain name is determined to be invalid, the domain name is reserved.

Further, validity check may be performed on the domain names in the query group according to domain name specifications. If a domain name meets the domain name specifications, the domain name is determined to be valid. If a domain name does not meet the domain name specifications, the domain name is determined to be invalid.

For example, it is stipulated in the domain name specifications that a domain name includes the following characters:

(1) 26 English letters;

(2) ten Arabic numerals “0, 1, 2, 3, 4, 5, 6, 7, 8, 9”;

(3) “-” (an English hyphen, but it should not be the first character);

(4) a Chinese domain name may further include a Chinese character, and must include a Chinese character (this is similar for Japanese, Korean, or other domain names).

For another example, the domain name specifications specify a combination rule of characters in a domain name:

(1) In a domain name registration query, English letters are case-insensitive, and simplified and traditional Chinese characters are not differentiated.

(2) The length of a domain name is limited. For example, a naming rule for CN domain names is as follows:

i. All common naming rules for domain names are followed.

ii. Only third-level domains may be registered, a third-level domain includes letters (A-Z, a-z, case-insensitive), digits (0-9), and hyphen (-), various levels of domain names are connected by using a solid dot (•), and the length of a third-level domain should not exceed 20 characters.

Certainly, the above domain name specifications are only used as an example. During implementation of the example embodiment of the present disclosure, other domain name specifications may be set according to actual conditions. For example, the length should not exceed 128 characters, the suffix of a domain name is fixed, and the like, which are not limited in the example embodiment of the present disclosure.

2. Disruption of Sequence

The sequence of domain names in the query group is disrupted.

In actual application, a filtering rule may be set for query interfaces of many servers by means of SPAM to shield malicious queries, thereby reducing the query load.

For example, sequential queries from 1 to 10000, queries in alphabetical order from A to WWWWWW, and so on.

Because the sequence of domain names is generally regular, the sequence of the domain names is disrupted, such as random allocation of domain names, to prevent a query failure caused by that the domain names are added to a blacklist by some query interfaces.

Certainly, the above pre-processing is merely used as an example. During implementation of the example embodiment of the present disclosure, other pre-processing such as de-duplication processing (that is, removing repeated domain names) may be set according to actual conditions, which is not limited in the example embodiment of the present disclosure. In addition to the above pre-processing method, those skilled in the art may further employ other pre-processing according to actual needs, which is not limited in the example embodiment of the present disclosure either.

In an example embodiment of the present disclosure, Step 108 may include the following sub-steps (not shown in FIG. 1):

A first sub-step of 108: A concurrent query quantity of the query interface of the matching query group is determined.

A second sub-step of 108: Domain names in the matching query group are allocated to the query interface until the concurrent query quantity is reached.

A third sub-step of 108: Domain name information of the allocated domain names is queried through the query interface.

In the example embodiment of the present disclosure, a query interface configured in a query group is used for querying domain name information of domain names to which a specified-level domain name corresponding to the query group belongs.

The domain names in the query group are allocated to the query interface randomly, sequentially, or in other manners.

When the quantity of the allocated domain names reaches the concurrent query quantity of the query interface, or all domain names are allocated, the query interface may be called to perform querying.

Generally, domain names may be allocated according to the sequence of query interfaces.

For example, as shown in FIG. 2, domain names may be allocated to a query interface API_1 206(1) first; after the allocation is completed, domain names are allocated to a query interface API_2 206(2); after the allocation is completed, domain names are allocated to a query interface API_3. 206(3); and so on.

In the example embodiment of the present disclosure, the query interface may include one or more of the following types:

1. Query Interfaces of a Domain Name Operator Server

In this manner, the domain name operator server encapsulates a domain name information query service thereof into a series of query interfaces, and opens the query interfaces to other users.

By calling a query interface of the domain name operator server, domain name information of domain names may be queried from the domain name operator server.

2. Query Interface of a Third-Party Server

In this manner, the third-party server queries domain name information of domain names from the domain name operator server, and the domain name information is cached in the third-party server; the third-party server encapsulates a domain name information query service thereof into a series of query interfaces, and opens the query interfaces to other users.

By calling a query interface of the third-party server, domain name information of domain names may be queried from the third-party server.

It should be noted that the third-party server is another server with respect to the domain name operator server and a local server.

3. Query Interfaces of a Local Server

In this manner, the local server queries domain name information of domain names from the domain name operator server, and the domain name information is cached in the local server. The local server encapsulates a domain name information query service thereof into a series of query interfaces, and opens the query interfaces to other local modules or other users.

By calling a query interface of the local server, domain name information of domain names may be queried from the local server.

4. Customized Query Interfaces

In an example implementation, customized query interfaces are applicable to non-standard environments.

For example, if a server provides one query interface and a format and a request parameter of the query interface are not a standard format and request parameter, customized development may be performed according to the standard, so that the interface meets the current data request standard.

In this manner, a server queries domain name information of domain names from the domain name operator server, and then the domain name information is cached in the server; the server encapsulates a domain name information query service thereof into a series of query interfaces, and opens the query interfaces to other users.

Customized development is performed on the query interface to obtain a customized query interface.

By calling the customized query interface that is newly developed, domain name information of domain names may be queried from the local server.

Certainly, the above query interface is merely used as an example. During implementation of the example embodiment of the present disclosure, other query interfaces may be set according to actual conditions, which are not limited in the example embodiment of the present disclosure. In addition to the above query interfaces, those skilled in the art may further employ other query interfaces according to actual needs, which are not limited in the example embodiment of the present disclosure either. In the example embodiment of the present disclosure, according to specifications of a query interface, a query service of a server to which the query interface belongs may be called to query domain name information of the domain name.

For example, as shown in FIG. 2, if the group corresponding to the top-level domains .com and .net 204 has query interfaces such as API_1 206(1), API_2 206(2), and API_3 206(3), these query interfaces may be called to query domain names in the query group to which the domain names belong.

The example embodiment of the present disclosure groups input domain names, and calls a query interface in the group to perform querying. Queries are performed by using a particular query interface, and settings of the query interface are maintained, thereby avoiding that settings of the query interface need to be switched due to queries for different types of domain names, and improving query efficiency and reducing a query time.

If no exception occurs in a query, the queried domain name information may include a Domain Name, a Name Server (DNS server), a Registrant ID, a Registrant Name, a Registrant Organization, a Registrant Address, a Registrant Email, a Registrant Phone Number, and the like.

Registered information and settings of domain name registration are different, and therefore, domain name information returned by the domain names may be all domain name information or a part of all domain name information.

Certainly, if the domain name has been registered, the returned domain name information has content, and if the domain name is not registered, the returned domain name information is null.

If a query is exceptional, for example, a query time expires, a returned result is missing or invalid (such as warning information), the domain name may be put back to the group for querying.

If a domain name is queried for more than N times (N is a positive integer, such as 3), and all queries are exceptional, a query failure result may be returned.

The example embodiment of the present disclosure allocates to-be-queried domain names to a matching query group according to a query capacity of the query group, and performs queries by using a query interface in the query group. In one aspect, by means of flexible domain name allocation, query resources are fully utilized, and the quantity of concurrent domain name queries is improved, thereby improving query efficiency and reducing a query time. In another aspect, queries are performed by using a particular query interface, and settings of the query interface are maintained, thereby avoiding that settings of the query interface need to be switched due to queries for different types of domain names, and improving query efficiency and reducing a query time.

In addition, the example embodiment of the present disclosure, by querying domain names in a non-block query manner, reduces a query time and reduce phenomena of timeout due to long-time waiting compared with block waiting.

For example, assuming that currently there are 100 domain names with the top-level domain .com, a query group is allocated with 4 query interfaces for domain names with the top-level domain .com, and concurrent query quantities of the 4 query interface are 5, 5, 10, and 10 respectively.

If queries are performed in a polling manner, and 4 domain names are queried each time, it takes 25 times of querying to complete querying of the 100 domain names.

By applying the example embodiment of the present disclosure, 30 domain names may be concurrently queried each time; with 3 times of querying using the 4 query interfaces at full load plus 1 time of querying using a query interface of which the concurrent query quantity is 10, querying of the 100 domain names is completed.

If the query interfaces, in which the concurrent query quantity is 10 for each query interface, are occupied, querying of the 100 domain names is completed in 3 times.

The non-block query manner in the example embodiment of the present disclosure reduces a waiting time of a user, reduces phenomena of timeout due to long-time waiting, and returns a single query result in a short time (such as 3 seconds).

For querying of more than 20 domain names, a waiting time in querying may be reduced by more than 50% compared with the polling manner.

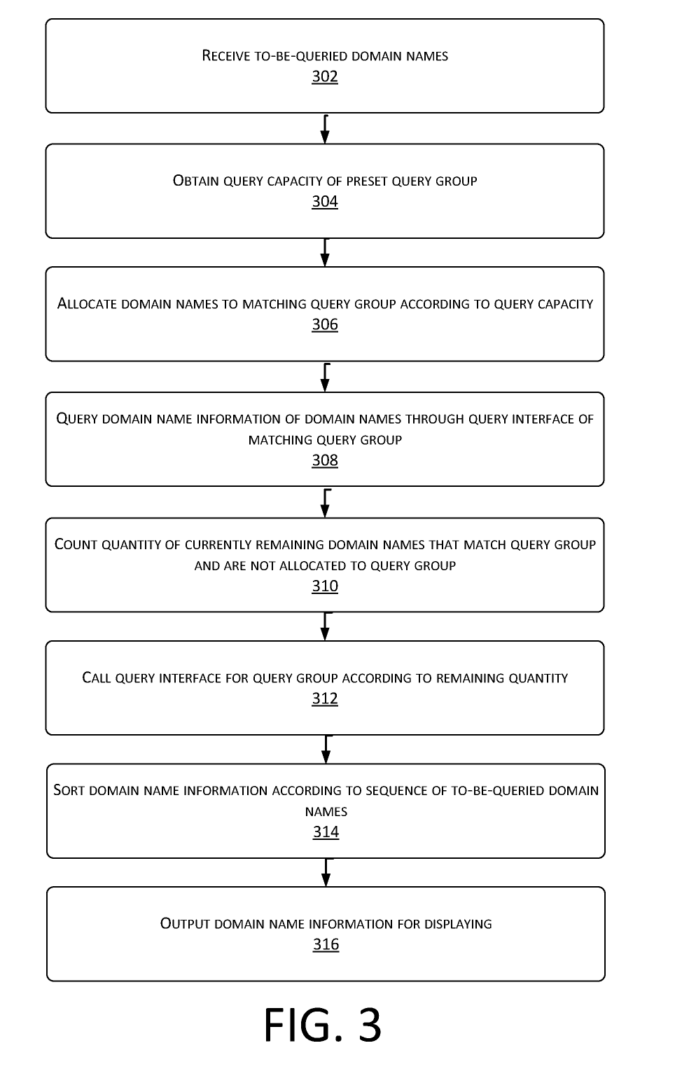

Referring to FIG. 3, a flowchart of the steps of example embodiment II of a method for querying domain name information according to the present disclosure is shown, which may specifically include the following steps:

Step 302: To-be-queried domain names are received.

Step 304: A query capacity of a preset query group is obtained.

Step 306: The domain names are allocated to a matching query group according to the query capacity.

Step 308: Domain name information of the domain names is queried through a query interface of the matching query group.

Step 310: The quantity of currently remaining domain names that match the query group and are not allocated to the query group is counted.

Step 312: A query interface is opened for the query group according to the remaining quantity.

The example embodiment of the present disclosure dynamically occupies or releases a query interface of a query group based on the quantity of remaining domain names, and fully utilizes query resources by means of flexible query interface configuration, and adjusts query interfaces with respect to domain names of different scales, thereby improving query efficiency and reducing a query time.

Because the query interface is dynamically adjusted, both types and the quantity of query interfaces in a query group may be dynamically changed.

In one situation, if there is a relatively large quantity of domain names that belong to a query group but are not allocated to the query group and querying of the domain names cannot be finished in one query while the system still has unoccupied query interfaces, a new query interface is dynamically occupied according to the remaining quantity to improve the concurrent query quantity.

Herein, the remaining quantity is proportional to the quantity of the new query interfaces. That is, the larger the remaining quantity is, the more new query interfaces are occupied.

In another situation, when the remaining quantity is zero, a query interface in an idle state is released.

If querying of domain names in a query group is finished, a query interface in an idle state in the group may be released to reduce occupied resources.

Step 314: The domain name information is sorted according to a sequence of the to-be-queried domain names.

In the example embodiment of the present disclosure, as the sequence of the domain names may be disrupted multiple times during domain name grouping and allocation to query interfaces, the queried domain name information may be combined, and indexes of the combined domain name information are restored according to the sequence of the to-be-queried domain names, so that the input to-be-queried domain names and the output domain name information have the same sequence to facilitate checking and future reference.

With respect to the normal query, the query result is domain name information returned by the query interface. With respect to the abnormal query, the query result is query failure information.

In addition, with respect to an unregistered domain name, the queried domain name information is null, and with respect to a registered domain name, the queried domain name information is information registered during registration of the domain name.

It should be noted that, with respect to repeated domain names, the query result may also be displayed repeatedly; with respect to an invalid domain name, the query result may be information that the domain name is invalid, and so on.

Step 316: The domain name information is output for displaying.

If a server obtains query results, the server may return the query results to a client terminal (such as a browser) for displaying.

If the query results are sorted, the sorted query results are output.

If the queried domain name information is in a foreign language (for example, in regions where Chinese, Japanese, and the like are used, English is a foreign language), which is difficult for ordinary users to read, the queried domain name information may be translated to be viewed by users conveniently.

Further, the domain name information generally employs a pairing form between information name (such as a Domain Name) and information content (such as sipo.gov.cn), and during translation, the information name may be translated, while information content is reserved.

In an example implementation, the server may return a page document, such as a Hypertext Markup Language (HTML) document, to a client terminal (such as a browser); the page document includes domain name information and a domain name information template, where the domain name information template may be, for example, JavaScript Object Notation (JSON) data, and has an information name in multiple translation name forms (such as Chinese).

When rendering the page document, the client terminal (such as a browser) may dynamically select the information name in a translation name form (such as Chinese) in the domain name information template according to the information name (such as English) of the domain name information, extract information content corresponding to the information name, and embed the information content at a position, in the domain name information template, indicated by the information name in the translated name form (such as Chinese).

To help those skilled in the art better understand the example embodiment of the present disclosure, the method for querying domain name information in the example embodiment of the present disclosure is described by using a specific example.

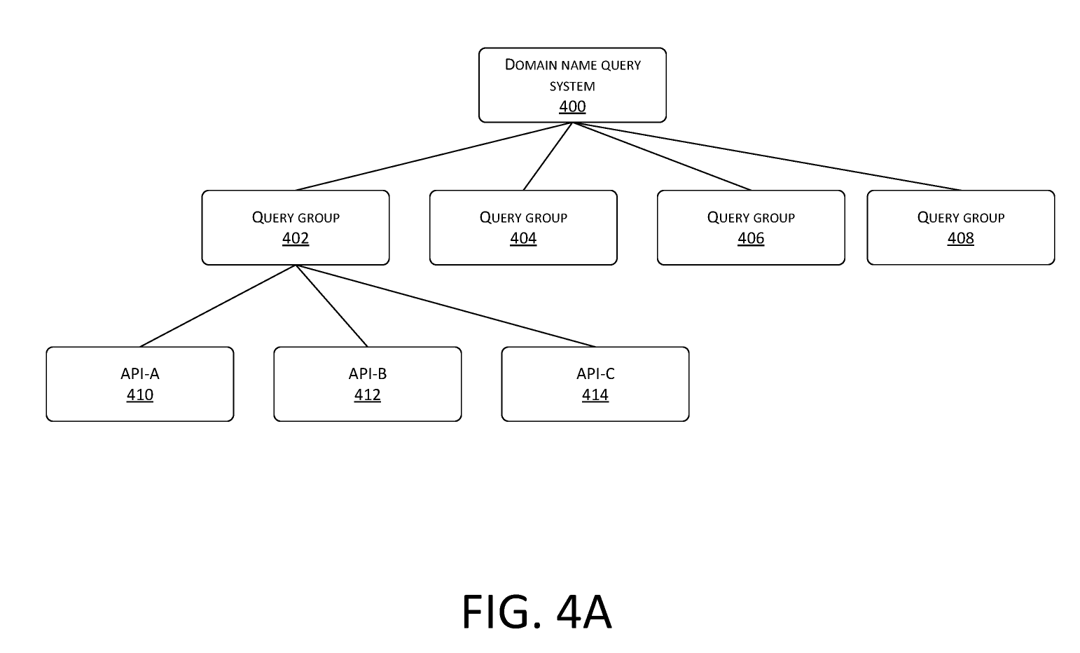

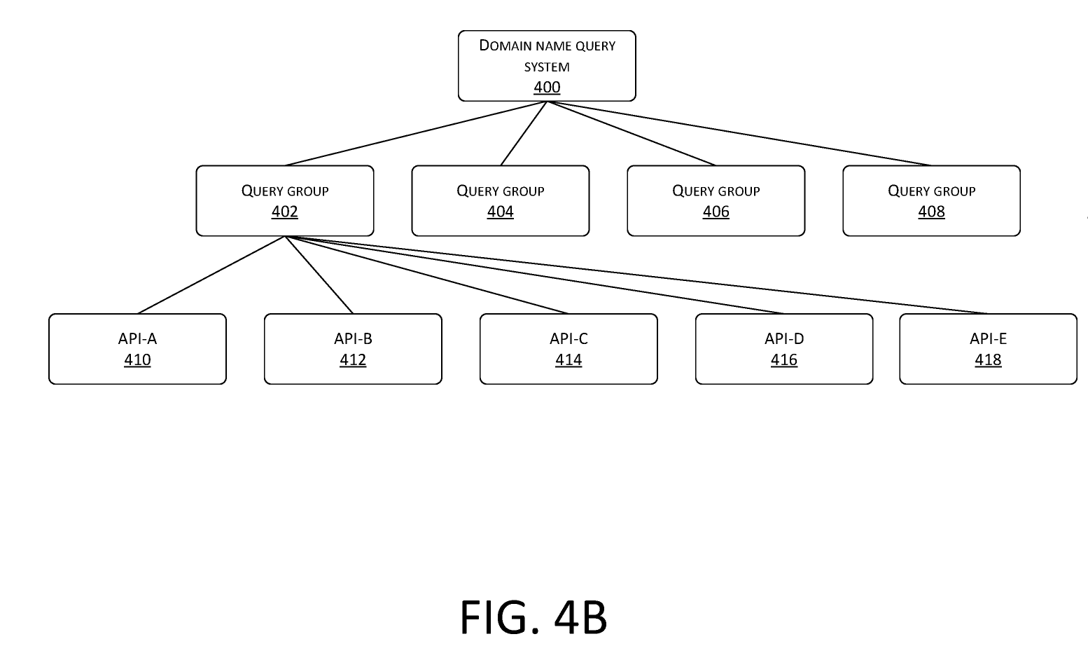

As shown in FIG. 4A, in a domain name query system 400, four query groups are provided, which correspond to four types of query interfaces respectively. A query interface of a query group 402 is used for querying domain name information of domain names having the top-level domains .com and .net; a query interface of a query group 404 is used for querying domain name information of domain names having the top-level domain .me; a query interface of a query group 406 is used for querying domain name information of domain names having the top-level domain.org; a query interface of a query group 408 is used for querying domain name information of domain names having the top-level domain .gov.

The query group 402 currently occupies 3 query interfaces: a query interface API_A 410 of a domain name operator server, a query interface API_B 412 of a third-party server, and a query interface API_C 414 of a local server, and concurrent query quantities of the 3 query interfaces are 3, 5, and 8 respectively.

A user accesses a webpage of a server through a browser, and submits a document on the webpage, where the document records 100 to-be-queried domain names, and formats of first several to-be-queried domain names are as follows:
sipo.gov.cn
www.sipo.com
sipo.net
sipo.org
. . .

where the quantity of domain names with the top-level domain .com is 50, the quantity of domain names with the top-level domain .net is 20, the quantity of domain names with the top-level domain .me is 18, the quantity of domain names with the top-level domain .org is 7, and the quantity of domain names with the top-level domain .gov is 5.

The 50 domain names with the top-level domain .com and the 20 domain names with the top-level domain .net, i.e., a total of 70 domain names, are allocated to the query group 402; the 18 domain names with the top-level domain .me are allocated to the query group 404; the 7 domain names with the top-level domain.org are allocated to the query group 406; and the 5 domain names with the top-level domain .gov are allocated to the query group 408.

For the query group 402, if the query interfaces API_A 410, API_B 412, and API_C 414 are used for querying at full load, which makes a total concurrent query quantity (that is, the query capacity) 16, 16 domain names with the top-level domain .com and the top-level domain .net may be randomly allocated to the group 401, and the remaining 54 domain names wait for the next query.

If 16 domain names with the top-level domain .com and the top-level domain .net are allocated to the query group 402, A3 domain names may be allocated to the query interface API_A 410 of the domain name operator server sequentially, and when the query interface API_A 410 of the domain name operator server is fully occupied, a query request is initiated to the domain name operator server to query domain name information of the 3 domain names.

5 domain names are continued to be allocated to the query interface API_B 412 of the third-party server, and when the query interface API_B 412 of the third-party server is fully occupied, a query request is initiated to the third-party server to query domain name information of the 5 domain names.

8 domain names are continued to be allocated to the query interface API_C 414 of the local server, and a query request is initiated to the local server to query domain name information of the 8 domain names.

As shown in FIG. 4B, in the next round of querying, the quantity of remaining domain name that are not queried in the query group 402 is 54, which is a relatively large quantity, and 2 more query interfaces for querying domain name information of domain names to which the top-level domains .com and .net belong are occupied, that is, a query interface API_D 416 of the third-party server and a query interface API_E 418 of the local server, to continue to query the remaining 54 domain names.

Indexes of the combined domain name information are restored according to the sequence of the domain names in the domain name set. In the case where the query is normal, the query result is domain name information returned by the query interface, and in the case where the query is abnormal or exceptional, the query result is query failure information

In addition, with respect to an unregistered domain name, the queried domain name information is null, and with respect to a registered domain name, the queried domain name information is information registered during registration of the domain name.

The query results are sorted as follows:

sipo.gov.cn----------------------domain name information
www. sipo.com-----------------domain name information
sipo.net--------------------------null
sipo.org--------------------------query failure
...

If the queried domain name information is in English, the queried domain name information may be translated.

For example, queried domain name information of the domain name sipo.gov.cn is as follows:
Domain Name: sipo.gov.cn
ROID: 20021209s10061s00004837-cn
Domain Status: serverDeleteProhibited
Domain Status: serverUpdateProhibited
Domain Status: serverTransferProhibited
Registrant ID: ant-669319
Registrant: [symbol] [symbol] (“State Intellectual Property Office of the People's Republic of China” in English)
Registrant Contact Email: www@cpon.cpo.cn.net
Sponsoring Registrar: [symbol] [symbol] (“Beijing SanFront Information Technology Company” in English)
Name Server: ns1.sipo.gov.cn
Name Server: ns2.sipo.gov.cn
Registration Time: 1999-09-28 00:00:00
Expiration Time: 2018-09-28 00:00:00
DNSSEC: unsigned

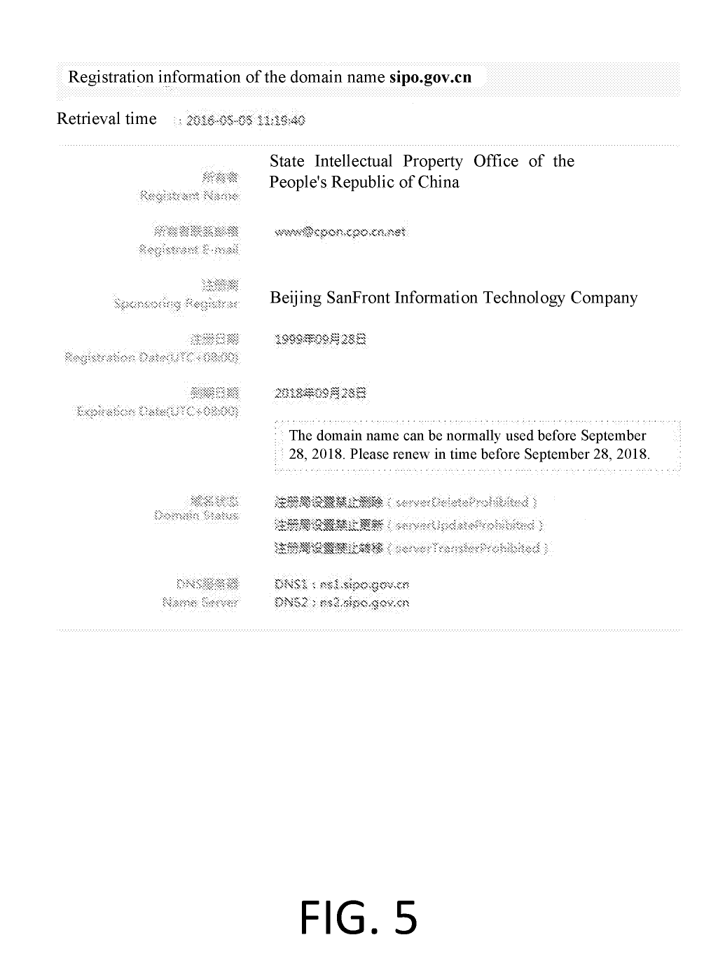

As shown in FIG. 5, translated domain name information may be displayed in the browser.

It should be noted that, for ease of description, the method example embodiment is expressed as a series of action combinations. However, it should be appreciated by those skilled in the art that the example embodiments of the present disclosure are not limited by the described action sequence, because according to the example embodiments of the present disclosure, some steps may be performed in another sequence or simultaneously. Further, it should also be appreciated by those skilled in the art that, all example embodiments described in the specification are merely examples, and involved actions are not necessarily mandatory to the example embodiments of the present disclosure.

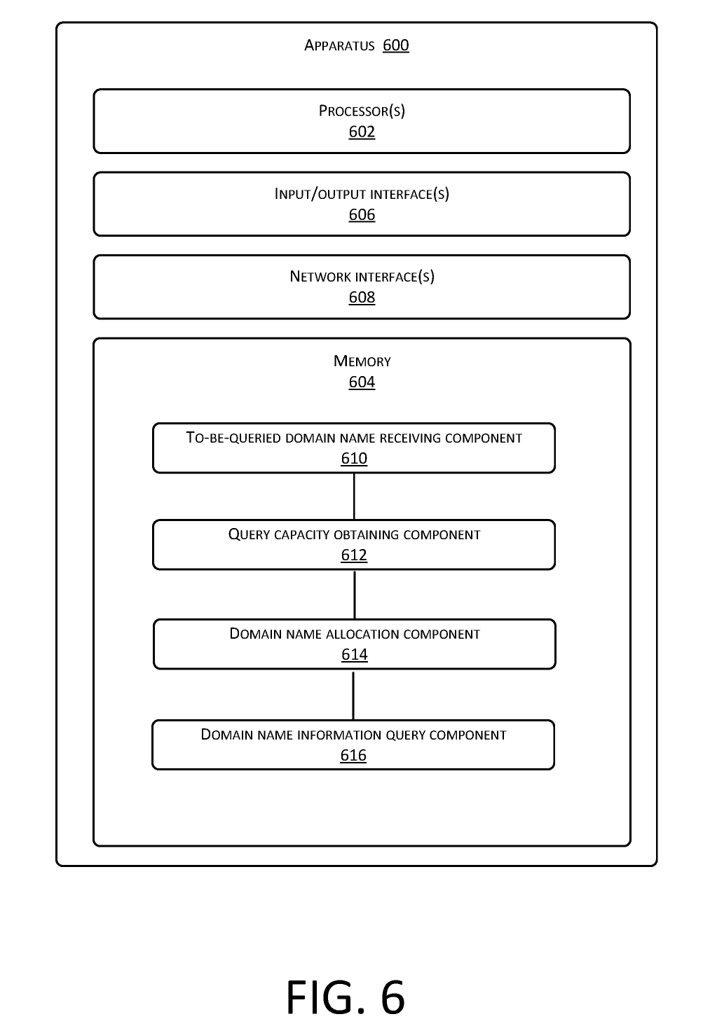

Referring to FIG. 6, a structural block diagram of an example apparatus 600 for querying domain name information according to the present disclosure is shown. The apparatus 600 includes one or more processor(s) 602 or data processing unit(s) and memory 604. The apparatus 600 may further include one or more input/output interface(s) 606, and network interface(s) 608. The memory 604 is an example of computer readable media.

The memory 604 may store therein a plurality of modules or units including:

a to-be-queried domain name receiving component 610 configured to receive to-be-queried domain names;

a query capacity obtaining component 612 configured to obtain a query capacity of a preset query group;

a domain name allocation component 614 configured to allocate the domain names to a matching query group according to the query capacity; and

a domain name information query component 616 configured to query domain name information of the domain names through a query interface of the matching query group.

In an example embodiment of the present disclosure, the query capacity obtaining component 612 may include the following sub-components:

a query interface identification sub-component configured to identify a query interface of the preset query group;

a concurrent query quantity searching sub-component configured to search for a concurrent query quantity of the query interface; and

a summation sub-component configured to calculate the sum of the concurrent query quantities to obtain the query capacity.

In an example embodiment of the present disclosure, the domain name allocation component 614 may include the following sub-components:

a level domain name identification sub-component configured to identify a specified-level domain name in the domain names;

a query group searching sub-component configured to search for a matching query group of the specified-level domain name, a query interface of the query group being used for querying domain name information of domain names to which the specified-level domain name belongs; and

a query group allocation sub-component configured to allocate the domain names to the query group according to the query capacity of the query group;

wherein the specified-level domain name includes one or more of the following types:

a top-level domain, a second-level domain, and a third-level domain.

In an example embodiment of the present disclosure, the domain name information query component 616 may include the following sub-components:

a concurrent query quantity determination sub-component configured to determine a concurrent query quantity of the query interface in the matching query group;

an interface filling sub-component configured to allocate domain names in the matching query group to the query interface until reaching the concurrent query quantity; and

an interface query sub-component configured to query domain name information of the allocated domain names through the query interface.

In an example embodiment of the present disclosure, the domain name information query component 616 may include the following sub-component:

a pre-processing sub-component configured to perform pre-processing on domain names in the group;

wherein the pre-processing includes:

performing validity check on the domain names in the group;

deleting the domain name when it is checked that the domain name is invalid;

and/or,

disrupting a sequence of the domain names in the group.

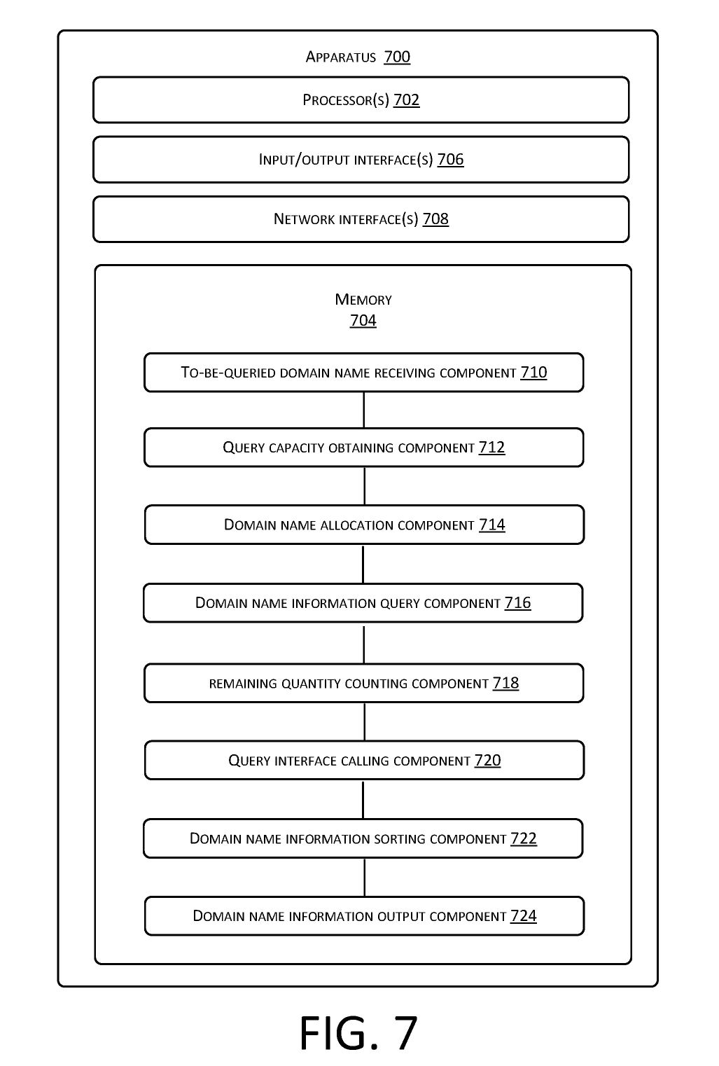

With reference to FIG. 7, a structural block diagram of another example apparatus 700 for querying domain name information according to the present disclosure is shown. The apparatus 700 includes one or more processor(s) 702 or data processing unit(s) and memory 704. The apparatus 700 may further include one or more input/output interface(s) 706, and network interface(s) 708. The memory 704 is an example of computer readable media.

The memory 704 may store therein a plurality of modules or units including:

a to-be-queried domain name receiving component 710 configured to receive to-be-queried domain names;

a query capacity obtaining component 712 configured to obtain a query capacity of a preset query group;

a domain name allocation component 714 configured to allocate the domain names to a matching query group according to the query capacity;

a domain name information query component 716 configured to query domain name information of the domain names through a query interface of the matching query group;

a remaining quantity counting component 718 configured to count the quantity of currently remaining domain names that match the query group and are not allocated to the query group;

a query interface calling component 720 configured to open a query interface for the query group according to the remaining quantity;

a domain name information sorting component 722 configured to sort the domain name information according to a sequence of the to-be-queried domain names; and

a domain name information output component 724 configured to output the domain name information for displaying.

In an example embodiment of the present disclosure, the query interface calling component 720 may include the following sub-components:

a query interface occupation sub-component configured to occupy a new query interface according to the remaining quantity, the remaining quantity being proportional to the quantity of the new query interfaces; or,

a query interface releasing sub-component configured to release a query interface in an idle state when the remaining quantity is zero.

Description of the apparatus example embodiment is relatively simple because it is substantially similar to the method example embodiment, and for related parts, reference may be made to the partial description of the method example embodiment.

The example embodiments in this specification are described in a progressive manner, each example embodiment focuses on a difference from other example embodiments, and for same or similar parts in the example embodiments, reference may be made to each other.

Persons of ordinary skill in the art should understand that, the example embodiments of the present disclosure may be provided as a method, an apparatus, or a computer program product. Therefore, the example embodiments of the present disclosure may be implemented in the form of a complete hardware example embodiment, a complete software example embodiment, or an example embodiment combing software and hardware. Moreover, the example embodiments of the present disclosure may employ the form of a computer program product implemented on one or more computer usable storage media (including, but not limited to, a magnetic disk memory, a CD-ROM, an optical memory, and the like) including computer usable program code.

In a typical configuration, the computer device includes one or more processors (CPUs), an input/output interface, a network interface, and a memory. The memory may include a volatile memory, a random access memory (RAM) and/or a non-volatile memory, for example, a read-only memory (ROM) or a flash RAM, or the like in a computer readable medium. The memory is an example of the computer readable medium. The computer readable medium includes non-volatile or volatile, and movable or non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage devices, or any other non-transmission medium, and can be used to store information accessible to the computing device. According to the definition in this text, the computer readable medium does not include transitory media, such as a modulated data signal and a carrier.

The example embodiments of the present disclosure are described with reference to flowcharts and/or block diagrams of the method, terminal device (system), and computer program product according to the example embodiments of the present disclosure. It should be understood that computer program instructions may be used to implement each process and/or block in the flowcharts and/or block diagrams and a combination of a process and/or a block in the flowcharts and/or the block diagrams. These computer program instructions may be provided for a general-purpose computer, a special-purpose computer, an embedded processor, or a processor of any other programmable data processing terminal device to generate a machine, so that the instructions executed by a computer or a processor of any other programmable data processing terminal device generate an apparatus for implementing a specified function in one or more processes in the flowcharts and/or in one or more blocks in the block diagrams.

These computer program instructions may also be stored in a computer readable memory that can instruct the computer or any other programmable data processing terminal device to work in a particular manner, such that the instructions stored in the computer readable memory generate an artifact that includes an instruction apparatus. The instruction apparatus implements a specified function in one or more processes in the flowcharts and/or in one or more blocks in the block diagrams.

These computer program instructions may also be loaded onto a computer or another programmable data processing terminal device, such that a series of operation steps are performed on the computer or another programmable terminal device, thereby generating computer-implemented processing. Therefore, the instructions executed on the computer or another programmable terminal device provide steps for implementing a specified function in one or more processes in the flowcharts and/or in one or more blocks in the block diagrams.

Although preferred example embodiments of the example embodiments of the present disclosure have been described, those skilled in the art may make other changes and modifications to these example embodiments once knowing the basic inventive concept. Therefore, the appended claims are intended to be interpreted as including the preferred example embodiments and all changes and modifications falling into the scope of the example embodiments of the present disclosure.

Finally, it further needs to be noted that the relational terms such as “first” and “second” herein are only used to differentiate one entity or operation from another entity or operation, but do not require or imply any actual relationship or sequence between these entities or operations. Moreover, the terms “include”, “comprise”, or any variants thereof are intended to cover a non-exclusive inclusion, such that a process, a method, an article or a terminal device that includes a series of elements not only includes such elements but also includes other elements not specified expressly, or may further include inherent elements of the process, method, article, or terminal device. Without more restrictions, an element limited by the phrase “include a/an . . . ” does not exclude other same elements existing in the process, method, article, or terminal device that includes the element.

A method for querying domain name information and an apparatus for querying domain name information provided in the present disclosure are described in detail above. Specific examples are used herein to illustrate the principle and implementations of the present disclosure. The description of the above example embodiments is merely used to help understand the method of the present disclosure and the core idea thereof; meanwhile, those of ordinary skill in the art may make changes to an example implementations and application scope according to the idea of the present disclosure. In conclusion, the content of the specification should not be construed as a limitation to the present disclosure.

What is claimed is:

1. A method comprising:
receiving domain names;
obtaining a query capacity of a query group;
allocating one or more domain names of the domain names to a matching query group according to the query capacity; and
querying domain name information of the one or more domain names through a query interface of the matching query group.

2. The method of claim 1, wherein the obtaining the query capacity of the query group includes:
identifying a query interface of the query group;
searching for a concurrent query quantity of the query interface; and
calculating a sum of the concurrent query quantities of all query interfaces of the query group to obtain the query capacity.

3. The method of claim 1, wherein the allocating the one or more domain names of the domain names to the matching query group according to the query capacity includes:
identifying a specified-level domain name in the domain names;
searching for a query group that matches the specified-level domain name, wherein a query interface of the query group is used for querying domain name information of the one or more domain names to which the specified-level domain name belongs; and
allocating the one or more domain names to the query group according to the query capacity of the query group.

4. The method of claim 3, wherein the specified-level domain name includes one or more of the following types:
a top-level domain;
a second-level domain; and
a third-level domain.

5. The method of claim 3, wherein the querying the domain name information of the one or more domain names through the query interface of the matching query group includes:
determining a concurrent query quantity of a query interface in the matching query group;
allocating the one or more domain names in the matching query group to the query interface until the concurrent query quantity is reached; and
querying domain name information of the one or more domain names through the query interface.

6. The method of claim 1, further comprising:
counting a remaining quantity of remaining domain names that match the query group and are not allocated to the query group; and
opening a query interface for the query group according to the remaining quantity.

7. The method of claim 6, wherein the opening the query interface for the query group according to the remaining quantity includes occupying one or more new query interfaces according to the remaining quantity.

8. The method of claim 7, wherein the remaining quantity is proportional to a quantity of the one or more new query interfaces.

9. The method of claim 6, wherein the opening the query interface for the query group according to the remaining quantity includes releasing a query interface in an idle state when the remaining quantity is zero.

10. The method of claim 1, further comprising:
sorting the domain name information according to a sequence of the domain names.

11. The method of claim 1, further comprising:
outputting the domain name information for display.

12. An apparatus comprising:
a to-be-queried domain name receiving component configured to receive domain names;
a query capacity obtaining component configured to obtain a query capacity of a query group;
a domain name allocation component configured to allocate one or more domain names of the domain names to a matching query group according to the query capacity; and
a domain name information query component configured to query domain name information of the one or more domain names through a query interface of the matching query group.

13. The apparatus of claim 12, wherein the query capacity obtaining component includes:
a query interface identification sub-component configured to identify a query interface of the query group;
a concurrent query quantity searching sub-component configured to search for a concurrent query quantity of the query interface; and
a summation sub-component configured to calculate the sum of the concurrent query quantities to obtain the query capacity.

14. The apparatus of claim 12, wherein the domain name allocation component includes:
a level domain name identification sub-component configured to identify a specified-level domain name in the domain names;
a query group searching sub-component configured to search for a matching query group of the specified-level domain name, a query interface of the query group being used for querying domain name information of the one or more domain names to which the specified-level domain name belongs; and
a query group allocation sub-component configured to allocate the domain names to the query group according to the query capacity of the query group,
wherein the specified-level domain name comprises one or more of the following types:
a top-level domain, a second-level domain, and a third-level domain.

15. The apparatus of claim 12, wherein the domain name information query component includes:
a concurrent query quantity determination sub-component configured to determine a concurrent query quantity of the query interface in the matching query group;
an interface filling sub-component configured to allocate the one or more domain names in the matching query group to the query interface until the concurrent query quantity is reached; and
an interface query sub-component configured to query domain name information of the one or more domain names through the query interface.

16. The apparatus of claim 12, further comprising:
a remaining quantity counting component configured to count a remaining quantity of remaining domain names that match the query group and are not allocated to the query group; and
a query interface calling component configured to open a query interface for the query group according to the remaining quantity.

17. The apparatus of claim 16, wherein the query interface calling component includes:
a query interface occupation sub-component configured to occupy occupying one or more new query interfaces according to the remaining quantity; or
a query interface releasing sub-component configured to release a query interface in an idle state when the remaining quantity is zero.

18. The apparatus of claim 12, further comprising:
a domain name information sorting component configured to sort the domain name information according to a sequence of the domain names.

19. The apparatus of claim 12, further comprising:
a domain name information output component configured to output the domain name information for display.

20. One or more memories stored thereon computer-readable instructions that, when executed by one or more processors, cause the one or more processors to perform acts comprising:
receiving domain names;
obtaining a query capacity of a query group;
allocating one or more domain names of the domain names to a matching query group according to the query capacity, the allocating the one or more domain names of the domain names to the matching query group according to the query capacity including:
identifying a specified-level domain name in the domain names;
searching for a matching query group of the specified-level domain name, a query interface of the query group being used for querying domain name information of the one or more domain names to which the specified-level domain name belongs; and
allocating the one or more domain names to the query group according to the query capacity of the query group; and
querying domain name information of the one or more domain names through a query interface of the matching query group.
